(19) United States
(12) Patent Application Publication
(10) Pub. No.: US 2024/0234905 A1
(43) Pub. Date: Jul. 11, 2024

(54) UNIVERSAL SECOND-LIFE EV BATTERY SHIPPING AND MOUNTING FRAME

(71) Applicant: Smartville, Inc., Carlsbad, CA (US)

(72) Inventors: William von Novak, San Diego, CA (US); Megan Lloyd, San Diego, CA (US); Trish Tran, Oceanside, CA (US); Aaron Leftwick, Vista, CA (US); Matthew Soohoo, Carlsbad, CA (US)

(21) Appl. No.: 18/407,724

(22) Filed: Jan. 9, 2024

Related U.S. Application Data
(60) Provisional application No. 63/479,100, filed on Jan. 9, 2023.

(51) Int. Cl. H01M 50/258; H01M 50/24; H01M 50/249; H01M 50/30

(52) U.S. Cl. CPC H01M 50/258; H01M 50/24; H01M 50/249; H01M 50/394; H01M 2220/20

(57) ABSTRACT

An adjustable shipping frame for an Electric Vehicle (EV) battery may comprise a lower housing. The lower housing may comprise a first mounting bar and a second mounting bar each having a plurality of rail attachment points. The first mounting bar may be parallel to the second mounting bar. The lower housing may further comprise a first support bar and a second support bar, wherein each of the first support bar and the second support bar may be connected to each of the first mounting bar and the second mounting bar. The lower housing may further comprise a first adjustable rail and a second adjustable rail, each of the first adjustable rail and the second adjustable rail may be configured to attach to each of the mounting bars by the plurality rail attachment points, wherein the first adjustable rail may be configured to attach to a first end of the EV battery and the second adjustable rail may be configured to attach to a second end of the EV battery.

### CROSS-REFERENCE TO RELATED APPLICATIONS

This application claims priority to and the benefit of, U.S. Provisional Patent Application No. 63/479,100, filed Jan. 9, 2023 and entitled “UNIVERSAL SECOND-LIFE EV BATTERY SHIPPING AND MOUNTING FRAME,” which are hereby incorporated by reference herein.

### FIELD OF INVENTION

The present disclosure relates generally to EV battery shipping and storage and, in particular, to universal adjustable frames for EV battery shipping and storage.

### BACKGROUND

Systems, methods, and devices that improve EV battery shipping and storage are desirable. Electric Vehicle (EV) battery shipping is becoming more commonplace and EV battery manufacture is ramping up rapidly. Although the need to ship an EV battery may arise under a number of circumstances, a particular need exists in shipping EV batteries after they have reached end of life in the EV application. Once an EV has reached the end of its life, its battery must be disposed of—recycled, reused (second life) or put in a landfill. Typically, the EV battery will need to be shipped from its present location to a recycler, remanufacturer, landfill, or the like.

Shipping used EV batteries can be difficult for a variety of reasons. Various country, federal, state, and local regulations can prohibit or strictly regulate the shipment of the used EV batteries. Many of these regulations are attempting to address real or perceived safety concerns associated with moving used EV batteries. The safety concerns associated with used EV batteries most often are associated with the possibility that the EV battery might self-ignite, burn, and potentially cause other batteries that are being shipped with the burning battery to ignite. Many transportation service providers are wary of such a thermal event causing damage to their payload if not their transport vehicle and nearby people. These concerns can be amplified if the used EV battery has been damaged in an auto accident, or if the prior history of the EV battery is unknown.

Other impediments to shipping batteries is that they are heavy, unwieldy, difficult to stack or pack in any safe concentrations, need to be protected against damage (or further damage) during transportation, and the like. Issues such as these and more tend to limit the reuse or recycling of batteries. Shipping safety is a very big concern for both EV second life battery suppliers (i.e. EV dealers, mechanics and salvage yards) and for shippers (who do not want their shipments damaged by a battery coming off a pallet, outgassing or burning). Therefore, there is a need for more safe and easy battery shipping and storage.

### SUMMARY

In an example embodiment, an adjustable shipping frame for an Electric Vehicle (EV) battery is disclosed. The device may comprise a lower housing. The lower housing may comprise a first mounting bar and a second mounting bar each having a plurality of rail attachment points. The first mounting bar may be parallel to the second mounting bar. In this embodiment, the lower housing may further comprise a first support bar and a second support bar, wherein each of the first support bar and the second support bar may be connected to each of the first mounting bar and the second mounting bar. In this example, the lower housing may further comprise a first adjustable rail and a second adjustable rail, each of the first adjustable rail and the second adjustable rail may be configured to attach to each of the mounting bars by the plurality rail attachment points, wherein the first adjustable rail may be configured to attach to a first end of the EV battery and the second adjustable rail may be configured to attach to a second end of the EV battery.

In an example embodiment, a system for a stackable shipping frame for one or more Electric Vehicle (EV) batteries is disclosed. The stackable shipping frame may comprise a first frame and a second frame, the first frame configured to stack on top of the second frame. In this example embodiment, the first frame may comprise an upper housing, the upper housing comprising one or more protrusions. In this embodiment the second frame may comprise a lower housing, the lower housing may comprise one or more channels, each of the one or more channels configured to receive the protrusions.

In another example embodiment, a method for adjusting a shipping frame for an EV battery is disclosed. The method may comprise attaching a first adjustable rail to a lower housing of a shipping frame, wherein the lower housing may comprise a first mounting bar and a second mounting bar: wherein a first end of the first adjustable rail may be attached to the first mounting bar and a second end of the first adjustable rail may be attached to the second mounting bar. The method may further comprise attaching a second adjustable rail to the lower housing wherein a first end of the second adjustable rail may be attached to the first mounting bar and a second end to a second mounting bar may be attached to the second mounting bar. The method may further comprise mounting the EV battery to the first adjustable rail and the second adjustable rail: wherein the EV battery may be mounted on a first end of the EV battery to the first adjustable rail, and the EV battery may be mounted on a second end of the EV battery to the second adjustable rail.

### BRIEF DESCRIPTION OF THE DRAWING FIGURES

Additional aspects of the present disclosure will become evident upon reviewing the non-limiting embodiments described in the specification and the claims taken in conjunction with the accompanying figures, wherein like numerals designate like elements, and:

FIG. 1 illustrates an EV battery storage frame including adjustable rails attached in a first position, in accordance with various embodiments.

FIG. 2 illustrates an EV battery storage frame including adjustable rails attached in a second position, in accordance with various embodiments.

FIG. 3 illustrates a stackable EV battery storage frame, in accordance with various embodiments.

FIG. 4 illustrates an outgassing protection system for an EV battery storage frame, in accordance with various embodiments.

FIGS. 5A and 5B illustrate a plurality of EV battery storage frames including an outgassing protection system, in accordance with various embodiments.

FIG. 6 illustrates a process for adjusting an EV shipping frame, in accordance with various embodiments.

### DETAILED DESCRIPTION

Reference will now be made to the example embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

Disclosed herein is a frame for EV battery shipping and storage. In various embodiments, the frame may be an adjustable frame, and/or a stackable frame. In various embodiments, the frame may be referred to as a shipping frame and/or a storage frame. In various embodiments, the frame may be used to secure one or more EV batteries for shipping and storage.

In accordance with various embodiments, an EV battery frame may include an adjustable frame to allow for attaching and shipping of various EV batteries. In various embodiments, the EV battery frame may be adjusted to allow one or more batteries to be firmly attached to the shipping frame. The batteries may be attached to the EV battery frame by connecting the mounting points of the EV battery to mounting points on the EV battery frame. In various examples, the EV battery may be connected to the EV battery frame using the same mounting points on the EV battery that were used for installation of the EV battery when it was installed into the vehicle. The use of the EV battery mounting points increases the safety of transporting the EV battery because the mounting points were originally designed for crashworthiness and are therefore generally the best locations to use to provide maximum resilience to transport shock and vibration. Further, the EV battery frame can be adjusted to allow for easy re-use with different size batteries. The adjustable frame can allow for easy shipment of several kinds of second life EV batteries (SLEVB), with various dimensions.

In various embodiments, the EV battery frame may be configured to stack on top of other EV battery frames. In various embodiments, the EV battery frame may comprise pins or other protrusions to stack on other EV battery frames. In various embodiments, the EV battery frame will be structured to provide support for the frames stacked on top. For example, the EV battery frame may comprise vertical bars at each corner of the frame to add support.

In various examples, the EV battery frame can entirely enclose and protect one or more batteries from damage. For example, in various embodiments, the EV battery frame can comprise a plurality of bars to enclose the one or more batteries. The EV battery frame can be a prismatic shape, where the bars are used to entirely enclose the batteries. In various examples, panels or other material may be placed on some or all of the walls of the EV battery frame to further enclose the and protect the batteries.

In various embodiments, the EV battery frame may be rugged to protect the EV batteries during storage and shipment. The EV battery frame may be made of metal or composite material. The EV battery frame may be sufficiently strong to handle mishandling and minor drops without damage. In various embodiments, the EV battery frame may be prismatic in shape. A benefit of a prismatic shaped EV battery frame is that it is more easily stackable. Moreover the frame may be any suitable shape.

In various embodiments, the EV battery frame may comprise shock isolators and/or compliant mounting points to reduce the odds of shock damage. In various embodiments, the structure of the EV battery frame may provide shock isolation. For example, the flexibility in the adjustable rails, mounting bars and support bars may provide shock absorption. Further, the EV battery frame, in various embodiments, may comprise springs positioned between each EV battery frame to provide greater shock absorption. The EV battery frame, in various embodiments, may allow for elasticity between mounting points and corners. In various embodiments, shock bushings or other discrete shock isolation devices may be used between the EV battery and the EV battery frame. In various embodiments, the bushings may provide electrical as well as shock isolation.

Further, the EV battery frame may include a fire mitigation systems. For example, the EV battery frame may include an isolation and/or extinguishing system. In various examples, the EV battery frame may include open holes for air and control system to close or isolate the battery past a certain temperature threshold. In various examples, the EV battery frame may include warning lights or sensors. In various embodiments, the warning lights or sensors of the EV battery frame may signal or indicate that a battery is too hot or that an exhaust is outgassing. In various embodiments, the EV battery frame may be fully enclosed with the exception of the outgassing or exhaust system. In various embodiments, the EV battery frame is all or partially enclosed to be able to withstand high pressures if it is going to be sealed and isolated (filtering air vents). In various examples, the EV battery frame may include insulation.

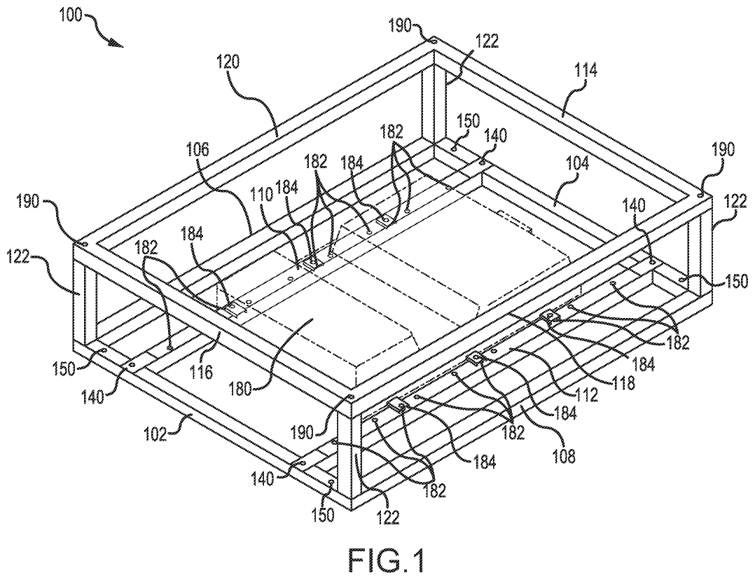

With reference to FIG. 1, in various embodiments an EV battery frame 100 may be configured to hold an EV battery 180. In various embodiments, the EV battery frame 100 may include multiple bars used to hold the EV battery 180. The EV battery frame 100 may include an upper housing and a lower housing.

In various embodiments, the lower housing of the EV battery frame 100 may include a first mounting bar 102, and a second mounting bar 104. In various examples, each of the first mounting bar 102 and the second mounting bar 104 may include one or more rail attachment points (i.e. inner rail attachment points 140 and outer rail attachment point 150). In various examples, the first mounting bar 102 may be parallel to the second mounting bar 104.

The lower housing of the EV battery frame 100 may further include a first support bar 106 and a second support bar 108. In various embodiments, the first support bar 106 may be parallel to the second support bar 108. In various embodiments, the first support bar 106 can be connected to the first mounting bar 102 and the second mounting bar 104. In various embodiments, the second support bar 108 can be connected to the first mounting bar 102 and the second mounting bar 104.

In various embodiments, the lower housing of the EV battery frame 100 may further include a first adjustable rail 110 and a second adjustable rail 112. The first mounting bar 102 and the second mounting bar 104 may be configured to mount or attach the one or more adjustable rails 110, 112 to the EV battery frame 100. There may be additional rail attachment points 140, 150 configured to attach the one or more adjustable rails 110, 112 to the EV battery frame at different distances from each other. For example, the first adjustable rail 110 and the second adjustable rail 112 can be attached to the respective inner rail attachment points 140 for a more narrow distance between the first adjustable rail 110 and the second adjustable rail 112. In various embodiments, the first adjustable rail 110 and the second adjustable rail 112 can be attached to the respective outer rail attachment points 150 for a relatively more wide distance between the first adjustable rail 110 and the second adjustable rail 112.

In various embodiments, the first adjustable rail 110 and the second adjustable rail 112 can each be configured to attach to each of the first mounting bar 102, and the second mounting bar 104 by the inner rail attachment point 140 and/or outer rail attachment point 150. In various embodiments, the first end of the first adjustable rail 110 can be attached to the inner rail attachment point 140 of the first mounting bar 102, and the second end of the first adjustable rail 110 can be attached to the inner rail attachment point 140 of the second mounting bar 104. Alternatively, in various embodiments, the first end of the first adjustable rail 110 can be attached to the outer rail attachment point 150 of the first mounting bar 102, and the second end of the first adjustable rail 110 can be attached to the outer rail attachment point 150 of the second mounting bar 104. In various examples, first end of the second adjustable rail 112 can be attached to the inner rail attachment point 140 of the first mounting bar 102, and the second end of the second adjustable rail 112 can be attached to the inner rail attachment point 140 of the second mounting bar 104. Alternatively, in various embodiments, the first end of the second adjustable rail 112 can be attached to the outer rail attachment point 150 of the first mounting bar 102, and the second end of the second adjustable rail 112 can be attached to the outer rail attachment point 150 of the second mounting bar 104. In various examples, there may be more attachments points to allow for varying distance between the first adjustable rail 110 and the second adjustable rail 112.

In various embodiments, the EV battery 180 can be attached to the EV battery frame 100. In various embodiments, the EV battery 180 can be attached to the EV battery frame 100 by using bolts extending through frame members to existing threaded mounting holes in the battery. In various embodiments, the EV battery 180 can be attached to the lower housing of the EV battery frame 100. In various embodiments, the EV battery 180 can be attached to the first adjustable rail 110 and/or the second adjustable rail 112. In various embodiments, the first adjustable rail 110 and the second adjustable rail 112 can have a plurality of battery frame mounting points 184. The plurality of battery frame mounting points 184 may be of various distances to attach to various battery sizes. In various embodiments, the EV battery 180 may comprise battery mounting points 184 on the EV battery. The battery mounting points 184 can be used to attach to the battery frame mounting points 182, so the EV battery 180 is attached to the adjustable rails 110, 112. For example, in various examples, the first adjustable rail 110 is configured to attach to a first end of the EV battery 180 and the second adjustable rail 112 is configured to attach to a second end of the EV battery 180. In various embodiments, the first end of the EV battery is attached to the first adjustable rail 110 by one or more battery frame mounting points 182. In various embodiments, the second end of the EV battery is attached to the second adjustable rail 112 by one or more battery frame mounting points 182. The EV battery 180 can be attached in multiple orientations to the EV battery frame 100.

In various embodiments, the battery frame mounting points 182 may be configured to attach to the battery mounting points 184 in various ways. For example, the battery mounting points 184 may be connected to the battery mounting points 182 using pins, threaded bushings, pins, clamps, or other suitable means. In various embodiments, the battery mounting points 184 may comprise holes, the holes configured to attach to a pin or threaded bushing of the battery frame mounting points 182.

Although not shown in FIG. 1, the EV battery 180, in various embodiments, can be attached to a first adjustable rail 110 and a first support bar 106. For example, first support bar 106 and/or second support bar 108 can have a plurality of battery mounting points (not shown). Further, the EV battery 180 may be attached to the second adjustable rail 112 and the second support bar 108. In various embodiments, the first mounting bar 102 and/or second mounting bar 104 may further include battery mounting points (not shown) for attaching the EV battery.

In various embodiments, the EV battery frame 100 may include an upper housing. The upper housing of the EV battery frame 100 may include a plurality of bars. The upper housing of the EV battery frame may be configured to protect the EV battery 180. The upper housing of the EV battery frame 100 may include a first horizontal support bar 118 and a second horizontal support bar 120. In various embodiments, the first horizontal support bar 118 and the second horizontal support bar 120 may be parallel to the first support bar 106 and the second support bar 108. The upper housing of the EV battery frame 100 may further comprise a first longitudinal support bar 114 and a second longitudinal support bar 116. The first longitudinal support bar 114 and the second longitudinal support bar 116 may be connected to each of the first horizontal support bar 118 and the second horizontal support bar 120. For example, in various embodiments, the first longitudinal support bar 114 may be connected to the first horizontal support bar 118 and the second horizontal support bar 120. The second longitudinal support bar can be connected to the first horizontal support bar 118 and the second horizontal support bar 120. In various embodiments, the first longitudinal support bar 114 may be parallel to the second longitudinal support bar 116. In various embodiments, the first longitudinal support bar 114 and the second longitudinal support bar 116 may be parallel to the first mounting bar 102 and the second mounting bar 104.

In various embodiments, the upper housing of the EV battery frame 100 may further include one or more vertical bars 122. In various embodiments, a plurality of vertical bars 122 may connect the first horizontal support bar 118, the second horizontal support bar 120, the first longitudinal support bar 114, and the second longitudinal support bar 116 to the lower housing. For example, in various embodiments the EV battery frame 100 may comprise four vertical bars 122, wherein each of the vertical bars 122 connect to a connection of either the first mounting bar 102 or the second mounting bar 104, and connect to a connection of either the first support bar 106 or the second support bar 108. Moreover, the upper housing may comprise any structure configured to protect the batteries and/or facilitate stacking, storing and shipping the EV batteries.

In various embodiments, the EV battery frame 100 may comprise frame connector points 190. In various embodiments, the frame connector points 190 may be on four corners of the top of the EV battery frame 100. In various embodiments, the frame connector points 190 may be configured to connect to other EV frames. In various embodiments, the frame connector points 190 may be for attaching pins to allow the frame to be moved be a forklift.

Although not shown in FIG. 1, the EV battery frame 100 may comprise channels. In various embodiments, the EV battery frame 100 may comprise channels to allow forklifts to lift the EV battery frame 100. For example, boxed in channels will allow insertion of forklift tines for moving EV battery frames 100. In various embodiments, although not shown, channels may be on the first support bar 106, the second support bar 108, the first mounting bar 102 and/or the second mounting bar 104 to allow for a forklift tines to insert into the EV battery frame 100 and move the EV battery frame 100. Although not shown in FIG. 1, in various embodiments, the EV battery frame 100 may comprise an enclosed forklift channel on the bottom of the EV battery frame 100.

In various embodiments, the EV battery frame 100 may include tie downs. In various embodiments, tie downs may be used to secure the EV battery frame for shipping, moving or storage. For example, tie downs may be used to restrain the EV battery frame and/or EV battery to prevent damage during shipping and/or storage. Further, in various embodiments, the EV battery frame may include notches or grooves to allow for tie downs to remain in position. Further, in various embodiments, the EV battery frame 100 may include notches or protrusions on top of the frame, such as frame connector points 190, configured to allow for retention of tie down straps. For example, the frame connector points 190 may comprise pins or protrusions configured to connect to tie down straps.

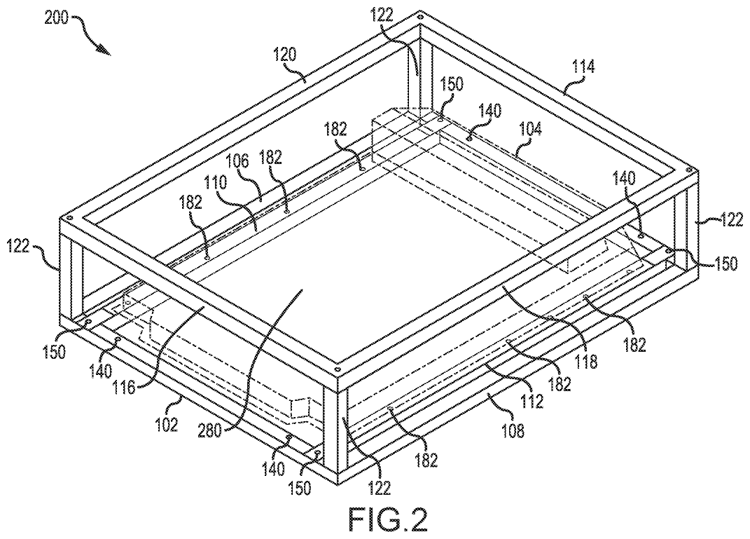

With reference to FIG. 2, and continued referenced to FIG. 1, the EV battery frame 200 can comprise an upper housing and a lower housing. FIG. 2 comprises like elements as described with similar reference in FIG. 1. In various embodiments, the EV battery frame 200 can be attached to an EV battery 280. In various embodiments, the EV battery frame 200 can be configured so the first adjustable rail 110 and the second adjustable rail 112 are attached to the outer rail attachment points 150. As shown in FIG. 2, the first adjustable rail 110 can be attached to the outer rail attachment point 150 on the first mounting bar 102 and the outer rail attachment point 150 on the second mounting bar 104. Further, the second adjustable rail 112 can be attached to the outer rail attachment point 150 of the first mounting bar 102 and the outer rail attachment point 150 on the second mounting bar 104. Further, in various embodiments, the mounting bars 102, 104 may include additional mounting points to allow for additional distances between the first adjustable rail 110 and the second adjustable rail 112.

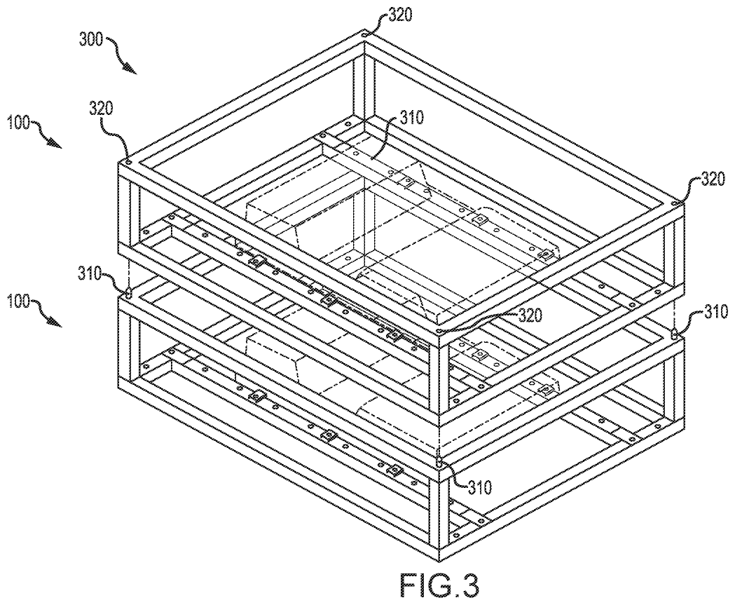

With reference to FIG. 3, in various embodiments, an EV battery stacking system 300 may be used to stack two or more EV battery frames 100 and/or EV battery frames 200. In various embodiments, the EV battery frame 100 may comprise one or more protrusions 310. In various embodiments, as shown in FIG. 3, the protrusions 310 may be pins. In various examples, the EV battery frame 100 may further comprise a receiving slot, the receiving slot configured to receive the protrusion 310. In an example embodiment, the upper housing and lower housing each have receiving slots configured to be aligned when stacked, and a protrusion 310 extends into each receiving slot to prevent lateral movement between the stacked frames. In various example embodiments, the protrusion 310 is permanently installed in the lower housing. In various embodiments, the one or more protrusions 310 are configured to selectively attach a first EV battery frame 100 to a second EV battery frame 100. Stated another way, in various embodiments, the EV battery frame may include a recess on the bottom of the lower housing to allow for stacking. Further, in various embodiments, the top of the upper housing may include pins. The pins on the top of the upper housing of a first EV battery frame 100 may fit into the recess on the bottom of the lower housing of a second EV battery frame 100. In various embodiments, the one or more protrusions 310 will allow the one or more EV battery frames 100 to stack for storage and transport, and prevent unwanted relative movement between the frames.

As an alternative to the protrusions 310, or in addition thereto, the EV battery frame 100 may comprise one or more notches or grooves. The notches or grooves of the EV battery frame 100 may be configured to receive a second EV battery frame 100, and prevent movement. The EV battery frame 100 may further comprise one or more protrusions, the protrusions of the EV battery frame 100 may be configured to fit into the notches or grooves of the EV battery frame 100 and prevent movement.

In various embodiments, the EV battery frame 100 may comprise threaded bushings 320. The threaded bushings 320 may allow insertion of screws. In various embodiments, the threaded bushings 320 may be configured to insert threaded protrusions 310. In various embodiments, the threaded bushings 320 may be used to insert screw attachments for using an overhead hoist to move frames and batteries. The threaded bushings 320 may be used to lift or move an EV battery frame with a forklift. The threaded bushings 320 may be located at four corners of the top of the EV battery frame 100.

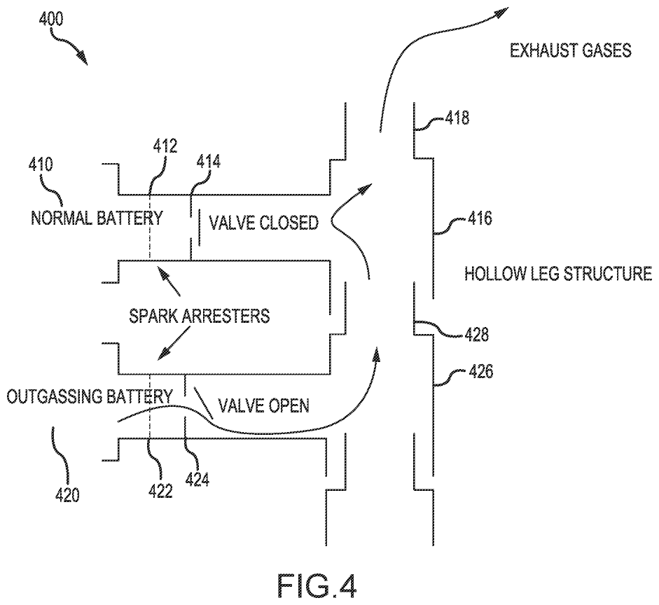

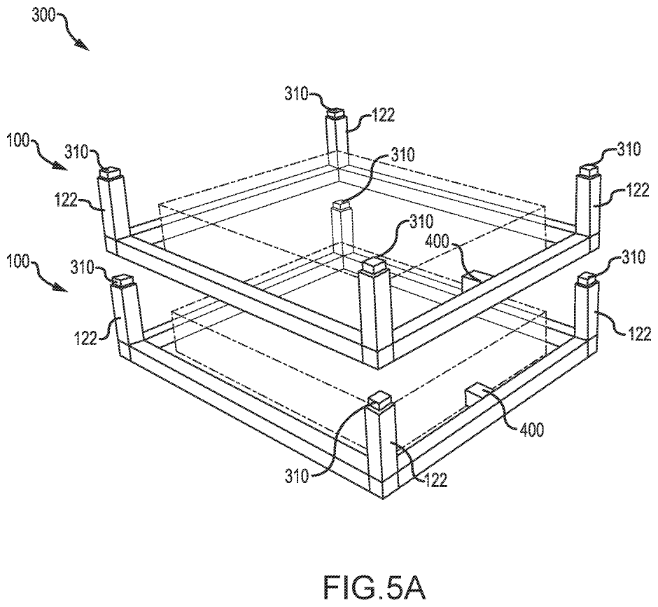

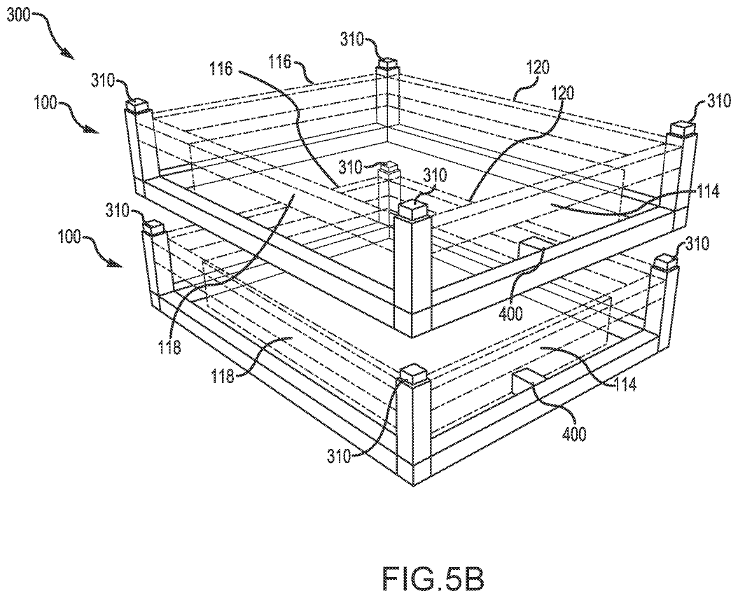

With reference to FIG. 4, in various embodiments, the EV battery frame may include an outgassing protection system 400. The outgassing protection system 400 can be included on various embodiments of the EV battery storage frame and EV battery shipping frames described throughout, including the EV battery frame 100 or EV battery frame 200. In various embodiments, the outgassing protection system 400 may contain features to isolate and/or contain a battery that starts outgassing or combusting. For example, the outgassing protection system 400 can prevent a battery outgassing or fire event from spreading from the EV battery frame or from propagating to other batteries. The outgassing protection system 400 may channel the flow of gas out of the hollow bars of the EV battery frame 100, as described in further detail with reference to FIGS. 5A and 5B. The outgassing protection system 400 may prevent flames, sparks and combustion products from reaching other batteries stored in EV battery frames 100. Stated another way, the outgassing protection system 400 may be configured such that the EV battery frame 100 serves the dual purpose of protecting the battery from external damage during shipping, and of channeling any off-gas products away from the battery.

In various examples, the outgassing protection system 400, may include an outgassing device for each of the one or more EV batteries. In various embodiments, the outgassing protection system 400 may be referred to as an “exhaust” or exhaust structure to describe the structure for outgassing gas, or exhaust. For example, as shown in FIG. 4, the outgassing protection system 400 can include multiple outgassing devices. In various embodiments, each outgassing device can be connected to an EV battery 410, 420 to allow for exhaust to release from the battery. In various embodiments, each outgassing device can include a spark arrester 412, 422, a valve 414, 424, a duct body 416, 426 and a duct neck 418, 428. The spark arrester 412, 422 can be connected to an EV battery 410, 420 to allow ducting of hot gases out of the enclosure without risk of igniting external materials. The spark arrester 412, 422 may be used to capture and contain sparks or small bits of material released by the battery. For example, the spark arrester 412, 422 may be a filter used to prevent ejection of combusting material from traveling out of the outgassing protection system 400.

In various embodiments, the valve 414, 424 may be connected to the output of the spark arrester 412, 422. Where the EV battery 410, 420 is outgassing, the respective valve 414, 424 may be a one-way valve to allow gases to exit, but prevent external contaminants from entering. The valve 414, 424 may connect to the duct body 416, 426. The duct body 416, 426 can allow the gasses to be released in a controlled/directed manner.

In various embodiments, the duct body 416, 426 can be in connection with the duct neck 418, 428. The duct neck 418, 428 can be smaller in diameter than the duct body 416, 426. The duct neck 418, 428 can be configured to fit into the duct body 416, 426 to allow gas to be released. In an example embodiment, when a top battery frame is stacked on a bottom battery frame, the duct neck 428 slides into the duct body 416 of the top battery frame to form an automatic connection and a battery exhaust chimney stack. In this example embodiment, the battery exhaust chimney stack is formed merely by stacking the battery frames one upon another. In various embodiments, the duct body 416, 426 and the duct neck 418, 428 can allow hot gases to outgas upwards through the hollow frame rails on either side to a common exhaust point in the case of stacked frames.

In various embodiments, the outgassing protection system 400 can further include an air filter (not shown) to allow ducting of hot gases out of the enclosure while reducing their toxicity.

The outgassing protection system 400 may include fireproof barriers to prevent escape of flame and/or sparks. In various embodiments, the fireproof barriers may be made of a composite material. For example, a thin steel backed by insulation material such as Kaowool. In various examples, the fireproof barriers can be made of a composite light weight material.

In various embodiments, the EV battery frame may include a heat sensor (not shown). The heat sensor may be in communication with the outgassing protection system 400. The heat sensor may activate the components of the outgassing protection system 400.

There are many benefits to the various embodiments described herein over prior battery storage systems, devices and methods. In a first example, the EV battery frame 100 and EV battery frame 200 are configured to adjust for batteries of various size and weight, allowing easy recycling and reuse for multiple shipments. In a second example, the EV battery frame 100 and EV battery frame 200 provide better support for the battery during storage and shipment, in addition to greater protection. In a third example, the EV battery stacking system 300 is configured to allow multiple EV battery frames 100, 200 to be easily stacked and stored during transport. In another example, the outgassing protection system 400 is configured to reduce the effects of exhaust during shipment.

With reference to FIGS. 5A and 5B, and as described with reference to FIG. 3, the EV battery frame 100, in various embodiments, comprises protrusions 310. In various embodiments, the protrusions 310 may be configured to fit into the bottom of a second EV battery frame 100. In various embodiments, the protrusions 310 may extend from one or more of the vertical bars 122 as shown in FIG. 5A. In various embodiments, the EV battery frame 100 may further comprise a first longitudinal support bar 114, a second longitudinal support bar 116, a first horizontal support bar 118 and the second horizontal support bar 120, as shown in FIG. 5B. In various embodiments, the various bars described herein are hollow to allow gas to enter and/or escape. In various embodiments, the protrusions 310 may be hollow with a narrower upper portion. As shown in FIGS. 5A and 5B the narrow upper portion of the protrusions 310 may be configured to fit into a receiving channel of a second EV battery frame 100. The protrusions 310 provide a means to prevent unwanted movement during transport, and creates a chimney extending through both vertical members.

With continued reference to FIGS. 5A and 5B, in various embodiment, the EV battery frame 100 may comprise an outgassing protection system 400, as described with reference to FIG. 4. In various embodiments, the outgassing protection system 400 may be configured to receive exhaust outgasses from a battery stored on the EV battery frame 100. The outgassing protection system 400 may be a duct connected to one or more of the bars of the EV battery frame 100. The outgassing protection system 400 may be in communication with the bars to allow gas to escape through the bars of the EV battery frame 100. Further, the outgassing protection system 400 may be in connection with the protrusions 310 to allow gas to escape through the outgassing protection system 400 and outward through the protrusions 310. For example, outgassing protection system 400 may work like a chimney to allow gas to be released from the battery and outward through the hollow bars of the EV battery frame 100.

The outgassing protection system 400 may additionally be configured to receive materials for fire extinguishing. For example, the outgassing protection system 400 may be connected to a fire hose or fire extinguisher to effectively and efficiently extinguish a battery.

In various embodiments, the EV battery frame 100 may include inserts (not shown) to close the receiving channels on the bottom of the EV battery frame 100. The inserts may allow the hollow bars on the bottom of the frame to close. For example, the inserts will close the hollow bars where the protrusions 310 may be inserted. In various embodiments, the inserts may be metal inserts. The inserts will allow the EV battery frame 100 to be closed off on the bottom to ensure that the combustion products, or other outputs from the battery escape upward rather than escape downwards. Further, in various embodiments, inserts may be placed on one or more of the protrusions 310. For example, inserts may be placed on three of the protrusions to direct the combustion products or gasses out one of the protrusions 310.

In various embodiments, panels (not shown) may fully or partially enclose the one or more EV battery frames 100. For example, metal panels may be attached to the sides of the EV battery frame 100 to enclose the battery and protect the battery. The panels may have an opening to allow the outgassing protection system 400 to release gas or other materials.

In various examples, the EV battery frame 100 may be configured to hold a plurality of batteries. The number of batteries stored in each EV battery frame may be determined by weight limits. For example, 3000 lbs. is a common storage shelf weight capacity, so where the batteries must be stored on shelves, the total weight of the batteries must not exceed the storage shelf weight capacity. For example, a Tesla Model S 60-100 kwhr battery weighs 900 to 1200 lbs. a Tesla Roadster 200 kwhr weighs about 1830 lbs. a Leaf 40 kwhr weighs about 770 lbs, and a GM Ultium 9 kwhr module weighs about 80 lbs. Therefore, the EV battery frame may be configured to hold various EV batteries at the same time however not exceeding the storage shelf weight capacity. For example, an EV battery frame might support one Roadster battery, two Model S batteries, three Leaf batteries or 12 Ultium battery modules. In various example embodiments, the adjustable rails can allow different battery widths to be mounted to the EV battery frame.

In various example embodiments, the size of the EV battery frame may vary. In various example embodiments, an EV battery frame may be configured to fit in a standard shipping container, a tractor trailer, or forklift storage. For example, a standard shipping container can have a maximum internal size of 92 inches, therefore, in one example embodiment, the smallest dimension of an EV battery frame for storage in a shipping container can be less than or equal to 92 inches. In various examples, tractor trailers have door openings that range in size from 87 to 93 inches, therefore, in an example embodiment, the smallest dimension of the EV shipping frame can be less than or equal to 87 inches. Next, in various example embodiments, a standard on-center distance between forks of a forklift is generally 48 inches, and with an enclosed fork channel it is recommended that the length of the object be less than twice the length of the forklift arms. Thus, in various example embodiments the dimensions of the EV battery frame can be less than or equal to 87 by 92 inches (LxW) for the frame to maximize ease of handling. In various example embodiments, the dimensions of the EV battery frame can be greater than 92 inches. Moreover, any length and width dimensions may be used.

Further, in various example embodiments, the height of the EV battery frame can vary. For example, the height of the EV battery frame may be of a height sufficient to fit in a storage container. In various embodiments, the EV battery frame may have a maximum width of 86 inches, a maximum length of 94 inches and a maximum height of 24 inches, therefore allowing for mounting of 2 Leaf batteries, 2 Ultium modules or 1 Tesla model S battery to fit. For example, the following are dimensions of common EV batteries: Leaf 61×47×10.4 inches, Tesla model S 85×49×14 inches. In various embodiments, the EV battery frames can be stacked any suitable number high. Moreover any suitable frame height of each EV frame may be used. In various embodiment, the EV battery frames are designed such that all the features of the battery are within the frame, thus protecting them from damage during shipment.

In various embodiments, the EV battery frame may be configured for integration into a Battery Energy Storage System (BESS). For example, the EV battery frame can be attached to a slide or a rail in a larger cabinet to allow mounting of several shipping frames inside a large BESS cabinet. Further, in various embodiments, the EV battery frame may include cutouts, access ports and other accessibility features configured to allow electrical connection of the batteries into a larger BESS.

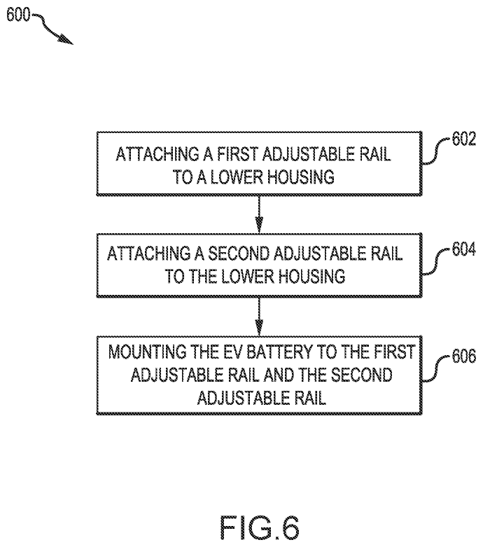

FIG. 6 is a flow diagram illustrating an example method 600 for adjusting a shipping frame for an EV battery. This example method may include attaching a first adjustable rail to a lower housing of an EV battery frame (step 602). For example, the lower housing comprises a first mounting bar and a second mounting bar. In various embodiments, a first end of the first adjustable rail may be attached to the first mounting bar and a second end of the first adjustable rail may be attached to the second mounting bar.

In accordance with various example embodiments, the method 600 may further include attaching a second adjustable rail to the lower housing (step 604). For example, a first end of the second adjustable rail may be attached to the first mounting bar and a second end of the second adjustable rail may be attached to the second mounting bar.

In accordance with various embodiments, the method 600 may further comprise mounting the EV battery to the first adjustable rail and the second adjustable rail (step 606). For example, the EV battery may be mounted on a first end of the EV battery to the first adjustable rail, and the EV battery may be mounted on a second end of the EV battery to the second adjustable rail.

In the present disclosure, the following terminology will be used: The singular forms “a.” “an.” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in the numerical range are individual values such as 2, 3 and 4 and sub-ranges such as 1-3, 2-4 and 3-5, etc. The same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be appreciated that the particular implementations shown and described herein are illustrative of the example embodiments and their best mode and are not intended to otherwise limit the scope of the present disclosure in any way. Furthermore, the connecting lines shown in the various figures contained herein are intended to represent example functional relationships and/or physical couplings between the various elements. It should be noted that many alternative or additional functional relationships or physical connections may be present in a practical device.

As one skilled in the art will appreciate, the mechanism of the present disclosure may be suitably configured in any of several ways. It should be understood that the mechanism described herein with reference to the figures is but one example embodiment of the disclosure and is not intended to limit the scope of the disclosure as described above.

It should be understood, however, that the detailed description and specific examples, while indicating example embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

What is claimed:

1. An adjustable shipping frame for an Electric Vehicle (EV) battery comprising:
a lower housing comprising:
a first mounting bar and a second mounting bar each having a plurality of rail attachment points, wherein the first mounting bar is parallel to the second mounting bar:
a first support bar and a second support bar, wherein each of the first support bar and the second support bar are connected to each of the first mounting bar and the second mounting bar; and
a first adjustable rail and a second adjustable rail, each of the first adjustable rail and the second adjustable rail configured to attach to each of the mounting bars by the plurality of rail attachment points, wherein the first adjustable rail is configured to attach to a first end of the EV battery and the second adjustable rail is configured to attach to a second end of the EV battery.

2. The adjustable shipping frame of claim 1 further comprising:
an upper housing configured to protect the EV battery.

3. The adjustable shipping frame of claim 2, wherein the upper housing comprises:
a first horizontal support bar and a second horizontal support bar, each of the first horizontal support bar and the second horizontal support bar are parallel to the first support bar and the second support bar:
a first longitudinal support bar and a second longitudinal support bar, the first longitudinal support bar and the second longitudinal support bar connected to each of the first horizontal support bar and the second horizontal support bar, wherein the first longitudinal support bar and the second longitudinal support bar are respectively parallel to the first mounting bar and the second mounting bar; and
a plurality of vertical bars, the vertical bars connecting the first horizontal support bar, the second horizontal support bar, the first longitudinal support bar, and the second longitudinal support bar to the lower housing.

4. The adjustable shipping frame of claim 2, wherein the upper housing comprises one or more protrusions, the protrusions configured to be inserted into a second adjustable shipping frame.

5. The adjustable shipping frame of claim 2, wherein the upper housing comprises one or more grooves, the grooves configured to prevent movement between the adjustable shipping frame and a second adjustable shipping frame.

6. The adjustable shipping frame of claim 1, further comprising an exhaust, the exhaust comprising a valve, wherein the valve is configured to release exhaust gasses.

7. The adjustable shipping frame of claim 1, further comprising an exhaust, wherein the exhaust is in communication with the EV battery to allow for outgassing of the EV battery.

8. The adjustable shipping frame of claim 7,
wherein the exhaust comprises a duct neck in connection with a duct body, the duct neck configured to connect with a second exhaust and output the exhaust through the second exhaust; and
wherein the duct body and the duct neck of the shipping frame and a second duct body of a second shipping frame form a chimney for exhausting the exhaust from the EV battery in either the first or second shipping frame to a common exhaust point, the chimney formed by stacking the adjustable shipping frame and the second shipping frame.

9. A stackable shipping frame system for one or more Electric Vehicle (EV) batteries comprising:
a first frame and a second frame, the first frame configured to stack on top of the second frame:
wherein the first frame comprises an upper housing, the upper housing comprising one or more protrusions; and
wherein the second frame comprises a lower housing, the lower housing comprising one or more channels, each of the one or more channels configured to receive the protrusions.

10. The stackable shipping frame system of claim 9, wherein the first frame further comprises a first exhaust, the first exhaust having a first valve, wherein the first valve is configured to release exhaust gasses.

11. The stackable shipping frame system of claim 9, wherein the second frame further comprises a second exhaust, the second exhaust having a second valve, wherein the second valve configured to release exhaust gasses.

12. The stackable shipping frame system of claim 11, wherein the stacking of the first frame and the second frame creates a chimney stack configured to receive a first exhaust and the second exhaust and to provide each to a common exhaust port.

13. The stackable shipping frame system of claim 11, wherein the one or more protrusions are hollow and in communication with a first exhaust, wherein the one or more protrusions are configured to allow exhaust gasses to escape from the first exhaust outward through the one or more protrusions.

14. A method for adjusting a shipping frame for an EV battery comprising:
attaching a first adjustable rail to a lower housing of a shipping frame,
wherein the lower housing comprises a first mounting bar and a second mounting bar:
wherein a first end of the first adjustable rail is attached to the first mounting bar and a second end of the first adjustable rail is attached to the second mounting bar;
attaching a second adjustable rail to the lower housing:
wherein a first end of the second adjustable rail is attached to the first mounting bar and a second end of the second adjustable rail is attached to the second mounting bar; and
mounting the EV battery to the first adjustable rail and the second adjustable rail;
wherein the EV battery is mounted on a first end of the EV battery to the first adjustable rail, and the EV battery is mounted on a second end of the EV battery to the second adjustable rail.

15. The method of claim 14, further comprising:
adjusting a distance between the first adjustable rail and the second adjustable rail to accommodate the length or width of a battery to be attached between the first and second adjustable rails.

16. The method of claim 14, further comprising:
stacking the shipping frame on top of a second shipping frame, wherein the shipping frame comprises protrusions configured to insert into channels on the second shipping frame.

17. The method of claim 14, further comprising:
releasing an exhaust from the EV battery, wherein the exhaust is released through an exhaust channel connected to the EV battery and the shipping frame.

18. The method of claim 17, wherein the exhaust is in communication with the lower housing and allows for the exhaust to release through the exhaust and through the lower housing.

19. The method of claim 14, wherein the shipping frame further comprises an upper housing, the upper housing comprising:
a first horizontal support bar and a second horizontal support bar, each of the first horizontal support bar and the second horizontal support bar are parallel to the first horizontal support bar and the second horizontal support bar:
a first longitudinal support bar and a second longitudinal support bar, the first longitudinal support bar and the second longitudinal support bar connected to each of the first horizontal support bar and the second horizontal support bar, wherein the first longitudinal support bar and the second longitudinal support bar are respectively parallel to the first mounting bar and the second mounting bar; and
a plurality of vertical bars, the vertical bars connecting the first horizontal support bar, the second horizontal support bar, the first longitudinal support bar, and the second longitudinal support bar to the lower housing.

20. The method of claim 19, wherein the upper housing further comprises one or more protrusions, and wherein the protrusions are configured to be inserted into a second shipping frame.
